(19) United States
(12) Patent Application Publication
(10) Pub. No.: US 2018/0022647 A1
(43) Pub. Date: Jan. 25, 2018

(54) EPOXY RESIN-CONTAINING CEMENT-BOUND COMPOSITION FOR ELECTRICALLY CONDUCTIVE COATINGS OR SEAL COATS

(71) Applicant: SIKA TECHNOLOGY AG, Baar (CH)

(72) Inventors: David TEICHERT, Kornwestheim (DE); Lars CONRAD, Bietigheim-Bissingen (DE); Jochen GRÖTZINGER, Schwäbisch Gmünd (DE)

(73) Assignee: SIKA TECHNOLOGY AG, Baar (CH)

(21) Appl. No.: 15/542,043

(22) PCT Filed: Jan. 12, 2016
(86) PCT No.: PCT/EP2016/050464

§ 371 Date: Jul. 6, 2017

(30) Foreign Application Priority Data
Jan. 15, 2015 (EP) 15151338.9

(51) Int. Cl. C04B 28/02; B05D 3/00; C04B 24/28

(52) U.S. Cl. CPC C04B 28/02; C04B 24/281; B05D 3/007; C04B 2111/60

(57) ABSTRACT

A multicomponent composition including: A) a binder component (A) including at least one epoxy resin, B) an aqueous hardener component (B) including at least one amine compound as an amine hardener and water, and C) a solid component (C) including at least one hydraulic inorganic binder, preferably cement, the multicomponent composition containing, relative to the total weight, at least 8% by weight of an organic binder, the total amount of epoxy resin and amine hardener constituting the organic binder, and at least one organic salt. The multicomponent composition preferably includes at least one pigment as the colorant. The multicomponent composition can be used to produce conductive floor coatings or floor seal coats suitable for ESD floor coatings. The coatings or seal coats can be produced in a large number of color hues.

### TECHNICAL FIELD

The invention relates to a multicomponent composition, to a method for producing a dissipative coating with the multicomponent composition, to a dissipative coating system, and to the use of the multicomponent composition for forming dissipative layers.

### PRIOR ART

Many segments of industry nowadays impose exacting requirements on optimum ambient conditions. Of the utmost importance in this context, in particular, is the prevention of uncontrolled electrostatic charging and discharge.

Electrostatic charging and discharge comes about as a result of contact, friction or separation of two materials. In the process, one material is positively charged, and the other negatively charged. In the case of floor coatings, this charge is generated by foot traffic or wheeled traffic, with rubber soles or rubber wheels, for example. Charging may also result from sweeping air on insulating surfaces, e.g., paints or coatings.

In sensitive areas, therefore, the requirement is for floors and walls with low resistances to ground, which dissipate electrostatic charging immediately and in a controlled manner. For electrostatically dissipative coatings of this kind, there are numerus standards in existence, containing test methods for assessing coatings for their suitability in respect of electrostatic or electrical behavior.

DIN EN 61340-4-1, for example, describes test methods for determining the electrical resistance of floor coverings and laid floors. In DIN EN 61340-4-5, the electrostatic safety is evaluated in combination with regard to the electrical resistance and the chargeability of people, footwear, and floor coverings.

There are coating systems known with ESD protection (ESD=“electrostatic discharge”), i.e., with protection from electrostatic discharge. Employed normally are dissipative systems based on epoxy resin or polyurethane. It is also known that wet concrete has sufficient conductivity to meet the standards of the DIN EN 61340 series.

Floors made from synthetic resins are commonly not conductive or dissipative. There are, nevertheless, two options for achieving ESD properties.

First of all, solid conductive particles of carbon black or metal, for example, may be added to the synthetic resin composition in order to achieve conductivity. These conductive particles are generally very expensive and have an intrinsic color, thereby inevitably lowering the shade selection and hence the decorative appeal of the product.

Another option is to use ionic liquids or to use organic salts which are soluble in the synthetic resin matrix, and which provide sufficient electrical conductivity. These options, however, reduce the mechanical and chemical resistance of the coating system. With this technology, moreover, a reduced-emission system is not possible, and so in many cases it is not possible to meet the requirements relating to VOCs (volatile organic constituents) in standards such as AgBB (German committee for evaluation of building products) or M1.

WO 2014/108310 A1 describes multicomponent compositions for a dissipative coating system, which may comprise reactive resins with fractions of cement. As additives for setting the electrical properties, it is possible to use additives such as salts or ionic liquids, for example.

EP 2821424 A1 describes a multicomponent composition comprising an epoxy component comprising an epoxy resin, a hardener component comprising a hardener and optionally water, and a cement component comprising cement and a filler, and also 0.1 to 10 wt % of a solid polymeric binder. The hardener may be a polyamine.

DE 102006015775 A1 relates to a high-build floor coating having antistatic properties, whose antistatic component comprises solutions of metal salts in ionic liquids—for this purpose, for example, ammonium salts or imidazolium salts are used in the coating composition.

EP 2826761 A1 relates to a multicomponent composition comprising a binder component A) comprising an epoxy resin, an aqueous hardener component B) comprising an amine compound, and a solid component C) comprising a hydraulic binder, the organic binder content being at least 8 wt %. Possible additives cited include tertiary amines and their salts, and quaternary ammonium salts.

### SUMMARY OF THE INVENTION

The object of the invention was therefore that of providing a composition for producing dissipative floor coatings which no longer have the above-described disadvantages of the prior-art systems. The composition is also to be suitable for coating systems featuring ESD requirements. The composition, moreover, is to be able to provide a floor coating having high mechanical and chemical stability, which at the same time allows a wide diversity of shades and appealing esthetics.

The object has surprisingly been achieved by means of an epoxy resin-enhanced, cement-bound composition which comprises an organic salt allowing the electrical conductivity of the coating to be adjusted.

The invention therefore relates to a multicomponent composition comprising
A) a binder component (A) comprising at least one epoxy resin,
B) an aqueous hardener component (B) comprising at least one amine compound as amine hardener and water, and
C) a solid component (C) comprising at least one hydraulic inorganic binder, preferably cement,
   where the multicomponent composition comprises at least 8 wt % of organic binder, based on the total weight, where the total amount of epoxy resin and amine hardener constitutes the organic binder, and where the multicomponent composition comprises an organic salt.

The addition of the organic salt raises the conductivity of the coating or seal coat obtainable by means of the composition, thus allowing electrical current to be transported from the surface through the coating/seal coat onto a conductive varnish, and/or allowing the current to be transported through the coating without conductive varnish down to grounding points. Dissipative coatings or seal coats are obtained. The requirements according, for example, to DIN EN 61340-4-1 or DIN EN 61340-4-5 can be fulfilled with such coatings and seal coats.

The composition preferably has a relatively high organic binder fraction. In one preferred embodiment the multicomponent composition comprises at least one pigment as coloring agent in order to obtain a colored coating or seal coat.

The multicomponent composition is outstandingly suitable for producing floor coatings or floor seal coats.

The layers obtained are of high mechanical strength and abrasion resistance and are also highly resistant to yellowing; furthermore, they are more chemical-resistant than conventional reactive resin systems, and are temperature stable and impervious to liquids. The composition may be formulated as a low-VOC or VOC-free (volatile organic components) system. As a result of compatibility with commercially available color paste systems, a wide diversity of shades is possible. The composition is inexpensive, has outstanding processing qualities, and can be processed either kneeling or standing.

Preferred embodiments of the composition are reproduced in the dependent claims. The invention is elucidated comprehensively below.

### BRIEF DESCRIPTION OF THE DRAWING

FIG. 1: Schematic diagram of an ESD coating system

FIG. 2: Schematic diagram of a further ESD coating system

### A CERTAIN EMBODIMENT OF THE INVENTION

Compound names beginning with “poly” identify substances which formally per molecule contain two or more of the functional groups which occur in their name. The compound may be monomeric, oligomeric, or polymeric. A polyamine, for example, is a compound having two or more amino groups. A polyepoxide is a compound having two or more epoxy groups.

Epoxy resins are polyepoxides, i.e., compounds having two or more epoxide groups. Epoxy resins are preferably oligomeric or polymeric compounds. Epoxy resins are also used in conjunction with what are known as reactive diluents. Reactive diluents are mono- or polyepoxides. The reactive diluents possess a viscosity lower than that of the epoxy resin used, and serve to reduce the viscosity of the epoxy resin used. The optional reactive diluent is likewise incorporated into the organic binder matrix, and for the purpose of determining the organic binder content is therefore included here with the epoxy resins.

The epoxide equivalent weight (EEW) can be determined according to DIN 53188 and is reported in g/eq. The NH equivalent weight can be determined according to DIN 16945 and is reported in g/eq. The stoichiometric ratio of epoxide functionality to amine functionality is the quotient formed between epoxide equivalent weight and NH equivalent weight, and is frequently reported in %. The NH equivalent weight here refers to the active NH hydrogens. A primary amine, for example, has two active NH hydrogens.

The composition of the invention comprises a multicomponent composition, meaning that the composition comprises a plurality of, more particularly three or more, individual components, which are mixed with one another only at use. Before use, the components are stored separately, in order to prevent spontaneous reaction. For use, the components are mixed with one another. Mixing is followed by the start of inorganic hydration reactions and organic crosslinking reactions, leading ultimately to the curing of the mixture.

The difference between coating and seal coat lies essentially in the amount of the composition of the invention that is applied. A seal coat is a coat for which a relatively small amount of material is applied, to give coat thicknesses of up to about 500 μm. Coat thicknesses even greater are generally referred to as coatings, although the transition from seal coat to coating is not sharply defined.

The composition of the invention comprises a binder component (A), a hardener component (B), and a solid component (C). It may be a three-component composition, consisting only of these three components. Alternatively, as and when required, the composition may also comprise one or more, further, additional components. If, for example, in the preferred embodiment, the multicomponent composition of the invention comprises pigments as coloring agents, these pigments may be present in at least one of the three stated components (A), (B) or (C) and/or in an additional pigment component (D).

It is clear that the fraction of a particular ingredient in the mixture of the components is dependent on the fraction of that ingredient in the component in question and on the mixing ratio of the components. Unless otherwise indicated, fractions or ratios of particular ingredients that are reported here are based on the appropriate or suitable weight fractions or weight ratios of the ingredients in the mixture of the components of the multicomponent composition. This composition is obtained, for example, by mixing of the components in suitable mixing ratios in accordance with usage instructions.

The multicomponent composition is an organic-inorganic hybrid composition where both the organic binder and the inorganic binder have binder function—that is, both binders can form a matrix for embedding solid particles and for attachment to a substrate.

For the production of dissipative coatings, electrically conductive floors with a defined resistance are generally necessary. The multicomponent composition comprises at least one organic salt allowing the electrical conductivity of the coating to be adjusted. For this purpose it is possible to use the organic salts which are known for providing conductivity to pure synthetic-resin coatings. Organic salts here are salts which have an organic cation and/or an organic anion. One or more organic salts may be used.

Examples of organic salts which can be used for adjusting the electrical properties of the multicomponent composition are organic ammonium salts and organic phosphonium salts, more particularly quaternary ammonium salts and quaternary phosphonium salts. Particularly preferred organic salts are tetraalkylammonium salts, tetraalkylphosphonium salts, imidazolium salts, pyrrolidinium salts, dicyanamides, or pyridinium salts. Preferred organic salts are organic ammonium salts, more particularly quaternary ammonium salts, such as benzyltriethylammonium chloride or dodecylethyldimethylammonium ethylsulfate, for example. Alkyl also includes aralkyls such as benzyl. Examples of suitable anions for the salts stated are, for example, halides, such as chloride, bromide, and iodide, dicyanamide, sulfate, alkylsulfate, or acetate.

The organic salts may be used for example in the form of powders, in liquid form, or as a solution or dispersion in a solvent.

The at least one organic salt may be present, for example, in the binder component (A), in the aqueous hardener component (B) or in the solid component (C) of the multicomponent composition. The at least one organic salt is preferably present in component (B). The organic salt may optionally be added as a separate component when mixing the three components, but generally this is not preferred.

The fraction of organic salt in the multicomponent composition is dependent, for example, on the nature of the salt and on the desired electrical properties, and may therefore vary within wide ranges. The multicomponent composition, based on the total weight, may comprise, for example, 0.5 to 15 wt %, preferably 1 to 10 wt %, of the at least one organic salt.

The binder component (A) comprises at least one epoxy resin and optionally a reactive diluent. The binder component (A) is preferably a liquid component. It may be viscous, but is generally pourable.

The binder component (A) comprises at least one epoxy resin. One epoxy resin or a mixture of two or more epoxy resins may be used. Epoxy resins which may be used are all epoxy resins customary within epoxy chemistry. Epoxy resins may be prepared, for example, in a known way from the oxidation of the corresponding olefins or from the reaction of epichlorohydrin with the corresponding polyols or polyphenols.

Epoxy resins can be divided into liquid epoxy resins and solid epoxy resins. The epoxy resin may have an epoxy equivalent weight, for example, of 156 to 500 g/eq. The epoxy resin is preferably a diepoxide.

In one embodiment, the epoxy resin may be an aromatic epoxy resin. Examples of resins suitable for this purpose are liquid epoxy resins of the formula (I),

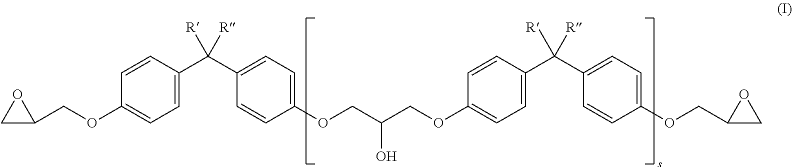

where R′ and R″ independently of one another are each a hydrogen atom or a methyl group, and s is on average a value from 0 to less than 2 and preferably 0 to 1. Preferred liquid resins are those of the formula (I) in which the index s is on average a value of less than 0.2.

The epoxy resins of the formula (I) are diglycidyl ethers of bisphenol A, bisphenol F and bisphenol A/F, with A being acetone and F being formaldehyde, which serve as reactants for the preparation of these bisphenols. Liquid epoxy resins of this kind are available commercially, as for example under the designations Araldite® from Huntsman, D.E.R.® from Dow, Epikote® from Momentive, Epalloy® from CVC, Chem Res® from BASF or Beckopox® from Allnex.

Further suitable aromatic epoxy resins are the products of glycidylization of:
dihydroxybenzene derivatives such as resorcinol, hydroquinone, and pyrocatechol;
other bisphenols or polyphenols such as bis(4-hydroxy-3-methylphenyl)methane, 2,2-bis(4-hydroxy-3-methylphenyl)propane (bisphenol C), bis(3,5-dimethyl-4-hydroxyphenyl)methane, 2,2-bis(3,5-dimethyl-4-hydroxyphenyl)propane, 2,2-bis(3,5-dibromo-4-hydroxyphenyl)propane, 2,2-bis(4-hydroxy-3-tert-butylphenyl)propane, 2,2-bis(4-hydroxyphenyl)butane (bisphenol B), 3,3-bis(4-hydroxyphenyl)pentane, 3,4-bis(4-hydroxyphenyl)hexane, 4,4-bis(4-hydroxyphenyl)heptane, 2,4-bis(4-hydroxyphenyl)-2-methylbutane, 2,4-bis(3,5-dimethyl-4-hydroxyphenyl)-2-methylbutane, 1,1-bis(4-hydroxyphenyl)cyclohexane (bisphenol Z), 1,1-bis(4-hydroxyphenyl)-3,3,5-trimethylcyclohexane (bisphenol TMC), 1,1-bis(4-hydroxyphenyI)-1-phenylethane, 1,4-bis[2-(4-hydroxyphenyI)-2-propyl]benzene (bisphenol P), 1,3-bis[2-(4-hydroxyphenyI)-2-propyl]benzene (bisphenol M), 4,4′-dihydroxybiphenyl (DOD), 4,4′-dihydroxybenzophenone, bis-(2-hydroxynaphth-1-yl)methane, bis(4-hydroxynaphth-1-yl)methane, 1,5-dihydroxynaphthalene, tris(4-hydroxyphenyl)methane, 1,1,2,2-tetrakis(4-hydroxyphenyl)ethane, bis(4-hydroxyphenyl) ether, bis(4-hydroxyphenyl) sulfone;
condensation products of phenols with formaldehyde, obtained under acidic conditions, such as phenol novolacs or cresol novolacs;
aromatic amines, such as aniline, toluidine, 4-aminophenol, 4,4′-methylenediphenyldiamine (MDA), 4,4′-methylenediphenyldi-(N-methyl)amine, 4,4′-[1,4-phenylene-bis(1-methylethylidene)]bisaniline (bisaniline P),[1,3-phenylene-bis(1-methylethylidene)]bisaniline (bisaniline M).

In a further embodiment, the epoxy resin may be an aliphatic or cycloaliphatic epoxy resin, such as, for example,
diglycidyl ether;
a glycidyl ether of a saturated or unsaturated, branched or unbranched, cyclic or open-chain C₂ to C₃₀ diol, such as ethylene glycol, propylene glycol, butylene glycol, hexanediol, octanediol, a polypropylene glycol, dimethylolcyclohexane, neopentyl glycol, for example;
a glycidyl ether of a tri- or tetrafunctional, saturated or unsaturated, branched or unbranched, cyclic or open-chain polyol such as castor oil, trimethylolpropane, trimethylolethane, pentaerythritol, sorbitol, or glycerol, and also alkoxylated glycerol or alkoxylated trimethylolpropane;
a hydrogenated liquid bisphenol A, F or A/F resin, and/or the products of glycidylization of hydrogenated bisphenol A, F or A/F;
an N-glycidyl derivative of amides or heterocyclic nitrogen bases, such as triglycidyl cyanurate and triglycidyl isocyanurate, and also reaction products of epichlorohydrin and hydantoin.

Further examples of epoxy resins that can be used are epoxy resins prepared from the oxidation of olefins, as for example from the oxidation of vinylcyclohexene, dicyclopentadiene, cyclohexadiene, cyclododecadiene, cyclododecatriene, isoprene, 1,5-hexadiene, butadiene, polybutadiene or divinylbenzene.

Other examples of epoxy resins which can be used are a solid bisphenol A, F or A/F resin constructed in the same way as for the aforementioned liquid epoxy resins of the formula (I), but with the index s having a value from 2 to 12. Other examples are all aforementioned epoxy resins, given a hydrophilic modification through reaction with at least one polyoxyalkylene polyol.

Preferred as epoxy resin are solid or liquid bisphenol A, F or A/F resins, of the kind available commercially, for example, from Dow, Huntsman, and Momentive. Particularly preferred epoxy resins used are diepoxides of a bisphenol A, bisphenol F, and bisphenol A/F diglycidyl ether, more particularly those having an epoxide equivalent weight of 156 to 250 g/eq, examples being the commercial products Araldite® GY 250, Araldite® PY 304, Araldite® GY 282 (from Huntsman); D.E.R. 331, D.E.R.® 330 (from Dow); Epikote® 828, Epikote® 862 (from Momentive), and of N,N-diglycidylaniline and a polyglycol diglycidyl ether, preferably having an epoxy equivalent weight of 170 to 340 g/eq, examples being the commercial products D.E.R.® 732 and D.E.R.® 736 (from Dow).

The binder component (A) may optionally comprise what is called a reactive diluent. This diluent, as stated, is counted as part of the epoxy resin for the organic binder fraction. One or more reactive diluents may be used. Suitable reactive diluents are mono- and polyepoxides. The addition of a reactive diluent to the epoxy resin has the effect of reducing the viscosity, and also, in the cured state of the epoxy resin composition, of reducing the glass transition temperature and the mechanical values.

Examples of reactive diluents are glycidyl ethers of mono- or polyhydric phenols and aliphatic or cycloaliphatic alcohols, such as, in particular, the polyglycidyl ethers of diols or polyols, already stated as aliphatic or cycloaliphatic epoxy resins, and also, furthermore, in particular, phenyl glycidyl ether, cresyl glycidyl ether, p-n-butylphenyl glycidyl ether, p-tert-butylphenyl glycidyl ether, nonylphenyl glycidyl ether, allyl glycidyl ether, butyl glycidyl ether, hexyl glycidyl ether, 2-ethylhexyl glycidyl ether, and also glycidyl ethers of natural alcohols, such as, for example, C₈ to C₁₀ alkyl glycidyl ethers, C₁₂ to C₁₄ alkyl glycidyl ethers, or C₁₃ to C₁₅ alkyl glycidyl ethers, available commercially as Erisys® GE-7, Erisys® GE-8 (from CVC), or as Epilox® P 13-19 (from Leuna).

The binder component (A) may be nonaqueous. In one preferred embodiment the binder component (A) is an aqueous binder component (A), i.e., it comprises water. The binder component (A) preferably comprises an aqueous epoxy resin dispersion, it being possible for this to be an epoxy resin emulsion, a so-called “emulsifiable epoxy resin”, or an epoxy resin suspension.

An epoxy resin dispersion comprises preferably, besides water, at least one epoxy resin, as stated above, and additionally at least one emulsifier, more particularly a nonionic emulsifier, as for example an alkyl or alkylaryl polyglycol ether, such as a polyalkoxylated alkylphenol such as alkylphenoxypoly(ethyleneoxy)ethanol, an example being a polyadduct of nonylphenol and ethylene oxide containing up to 30 mol of ethylene oxide per mole of nonylphenol, or, preferably, an alkoxylated fatty alcohol, an example being an ethoxylated fatty alcohol. Epoxy resin dispersions may have a solids content, for example, in the range of 40 - 65 wt %.

Commercial epoxy resin dispersions are, for example, Sika® Repair / Sikafloor® EpoCem® Module A (from Sika Schweiz AG), Araldite® PZ 323, Araldite® PZ 756/67, Araldite® PZ 3961 (from Huntsman), XZ 92598.00, XZ 92546.00, XZ 92533.00 (from Dow), Waterpoxy® 1422, Waterpoxy® 1455 (from BASF), Beckopox® EP 384w, Beckopox® EP 385w, Beckopox® EP 386w, Beckopox® EP 2340w, Beckopox® VEP 2381w (from Allnex).

An emulsifiable epoxy resin preferably comprises at least one emulsifier, as already mentioned above as a constituent of an epoxy resin dispersion. Commercial emulsifiable epoxy resins are, for example, Araldite® PY 340 and Araldite® PY 340-2 (from Huntsman), Beckopox® 122w and Beckopox® EP 147w (from Allnex).

The binder component (A) may optionally comprise one or more other additives. Suitable additives are elucidated further on below.

The hardener component (B) comprises at least one amine compound as amine hardener and water. The aqueous hardener component (B) is preferably a liquid component. It may be viscous, but is generally pourable.

The amine compound may be any amine compound commonly used in the art as a hardener for epoxy resins. Such amine hardeners are available commercially. One amine compound or two or more amine compounds may be used. Suitable in principle as amine compounds are monoamines, provided the amine is a primary amine, but compounds having at least two amine groups are more preferred. The amino groups may be primary and/or secondary amino groups. It is also possible, optionally, to use blocked amine compounds.

Examples of suitable amine compounds as amine hardeners are a polyamine, a polyaminoamide, a polyamine-polyepoxide adduct or a polyaminoamide-polyepoxide adduct, and mixtures thereof, containing in each case in particular at least two amino groups, it being possible optionally for the amino groups to be present in blocked form, although this is generally not preferred.

They may for example be aliphatic polyamines, such as diethylenetriamine, triethylenetetramine, dipropylenetriamine, tetraethylenepentamine, 3-aminomethyl-3,5,5-trimethylcyclohexylamine, m-xylylenediamine, or polyoxypropylenediamine, cycloaliphatic and/or heterocyclic polyamines, such as 4,4′-diamino-3,3′-dimethyldicyclohexylamine, cyclohexylaminopropylamine, or N-aminoethylpiperazine, polyaminoamides, obtainable for example from a dimer fatty acid and a polyamine, such as ethylenediamine, for example, or polyaminoimidazolines. Examples of blocked amine compounds are, for example, polyketimines, obtained by reaction of polyamines with ketones, or cyanoethylated polyamines from the reaction of polyamines with acrylonitrile, such as dicyandiamide in unmodified or modified form.

Frequently also used as amine hardeners are polyamine-polyepoxide adducts or polyaminoamide-polyepoxide adducts. These are obtained from the reaction of polyamines or polyaminoamides, examples being those stated above, with polyepoxides, with the polyamine and/or polyaminoamide being used in excess.

The hardener component (B) may optionally comprise one or more other additives. Suitable additives are elucidated further on below.

Solid component (C) comprises a hydraulic inorganic or mineral binder, which is preferably a cement. Two or more hydraulic inorganic binders may also be used. Component (C) is a solid component and is preferably pulverulent.

Hydraulic inorganic binders are inorganic or mineral binders which are hardenable with water even underwater. Hydraulic inorganic binders here also include those known as latent hydraulic binders, which set with water under the action of adjuvants, such as blast furnace slag, for example.

Examples of suitable hydraulic inorganic binders are hydraulic lime, cement, fly ash, rice husk ash, calcined recycling products of the paper industry, slag sand, and blast furnace slag, and mixtures thereof, with cement being particularly preferred. All customary cement grades can be used, particularly a cement according to European standard EN 197. Of course, cement grades in accordance with another cement standard may also be used. It is possible to use one cement or a mixture of different cement grades.

Preferred cements are Portland cements, sulfoaluminate cements, and high-alumina cements, more particularly Portland cement. Mixtures of cements may lead to particularly good properties. Examples are mixtures of at least one Portland cement with either at least one sulfoaluminate cement or with at least one high-alumina cement. The use of white cement is particularly advantageous.

The solid component (C) may further comprise one or more additional additives. Examples are calcium sulfate in the form of anhydrite, hemihydrate gypsum or dihydrate gypsum; and/or calcium hydroxide, various types of sand, or finely ground quartz, silica dust, pozzolans, and auxiliaries and admixtures customary within the cement industry, such as, for example, plasticizers, setting accelerators, water reducers, or deaerating/defoaming agents.

In one particularly preferred embodiment of the invention the multicomponent composition comprises one or more pigments as coloring agents. In this way a colored composition is obtained, from which colored coatings can be obtained, this being particularly preferred. In this way it is possible for colored compositions and colored coatings to be obtained that differ from the otherwise customary gray compositions and coatings, respectively. Mixtures of two or more pigments are advantageous, in order to produce a desired shade.

The multicomponent composition is especially compatible with pigments in the customary commercial forms, and so a broad palette of shades is possible. The pigment or pigments may be present in at least one of the components, A), B), or C) and/or in at least one additional pigment component, D).

The pigments may be inorganic or organic pigments. Examples of inorganic pigments are titanium dioxide, carbon black, bismuth pigments, iron oxide pigments, chromium oxides, mixed phase oxide pigments, Prussian Blue, ultramarine, cobalt pigments, and chromate pigments. Examples of organic pigments are azo pigments and polycyclic pigments such as copper phthalocyanine, quinacridone, diketopyrrolopyrrole, perylene, isoindoline, dioxazine, and indanthrone pigments.

The pigment or mixtures of pigments may be used as such in solid form, as powder or muller pigment, or as a customary pigment preparation, in the form of a pigment paste, for example. Suitable pigments are all commercially available pigments or pigment preparations. The pigments can be incorporated directly, by trituration, for example, into the liquid components (A) and (B), or may be introduced in the form of a pigment preparation—a pigment paste, for example. The pigment or pigments in solid form, as muller pigment, for example, may be incorporated by mixing into the solid component (C). It is likewise possible for the pigment or pigments to be held separately, as powder or muller pigment or pigment preparation, in the form of a pigment paste, for example, as an additional pigment component (D), and mixed with the other components only on use.

The multicomponent composition of the invention is advantageous in that commercial pigments or pigment preparations can easily be incorporated homogeneously by mixing into the composition, enabling even non-gray shades for the compositions or coatings in a broad palette.

In one preferred embodiment the multicomponent composition comprises sand, it being possible for the sand to be present in the solid component (C) and/or in an additional component.

As and when required, as well as the three components stated, the multicomponent composition may comprise further, additional components. Examples of such optional additional components are the aforementioned pigment component (D). Furthermore, for example, a portion of the water may be present as a standalone component, added only on mixing of the components prior to use, in order to set the desired amount of water. Sand may optionally also be used in the form of an additional standalone component. The organic salt as well may be in the form of a separate component.

Further optional additives which may be present, in particular, in the binder component (A) and/or in the hardener component (B), but also, optionally, in one or more other components, are additives customarily used within this field, such as, for example, nonreactive diluents, solvents, or film-forming assistants; reactive diluents and extenders, examples being reactive diluents containing epoxide groups, as already mentioned above; polymers, thermoplastic polymers; inorganic and organic fillers, such as ground or precipitated calcium carbonates, barite, talcs, finely ground quartzes, silica sand, dolomites, wollastonites, kaolins, micas, aluminum oxides, aluminum hydroxides, silicas, PVC powders, or hollow beads, for example; fibers; accelerators which accelerate the reaction between amino groups and epoxide groups, examples being acids or compounds that can be hydrolyzed to acids; rheology modifiers, such as thickeners, for example; adhesion promoters, such as organoalkoxysilanes, for example; stabilizers to counter heat, light, or UV radiation; flame retardants; surface-active substances, such as wetting agents, flow control agents, deaerating agents, or defoamers, for example; and biocides.

The multicomponent composition of the invention is a hybrid system which comprises an organic binder composed of the at least one epoxy resin and optionally reactive diluents of the binder component (A), and of the amine hardener of the hardener component (B), and an inorganic binder composed of the hydraulic inorganic binder, preferably cement, in the solid component (C).

The organic binder here is the total amount of epoxy resin and amine hardener, and, if reactive diluent is also used, it is counted among the epoxy resin with regard to the total amount. Based on the total weight, the multicomponent composition comprises at least 8 wt %, preferably at least 10 wt %, and more preferably at least 11 wt %, of organic binder. In general the multicomponent composition comprises not more than 40 wt % and preferably not more than 30 wt % of organic binder, based on the total weight.

The multicomponent composition further comprises preferably 0.5 wt % to 20 wt %, preferably 1.5 wt % to 10 wt %, of pigment, as coloring agent, based on the total weight.

The multicomponent composition further comprises preferably 8 wt % to 50 wt %, preferably 15 wt % to 40 wt %, of hydraulic inorganic binder, preferably cement or cement in combination with another hydraulic inorganic binder.

The mixing ratio between the binder component (A) and the hardener component (B) may vary within wide ranges. It is preferably selected such that in the multicomponent composition, the stoichiometric ratio of epoxide functionality to amine functionality is in the range from 0.75 to 1.25 (or 75% to 125%).

The amount of water in the multicomponent composition may likewise vary within wide ranges, the amount of water in the multicomponent composition preferably being selected such that the weight ratio of water to hydraulic inorganic binder, preferably cement, is in the range from 0.3 to 0.8. Water is present in the hardener component (B). Water may also be present in the binder component (A), and this is also preferred. Furthermore, a portion of the water may also be added separately as a standalone component.

The invention also relates to a method for producing a dissipative coating system, preferably a floor coating system, comprising a dissipative coating or a dissipative seal coat composed of the multicomponent composition of the invention, the method comprising the following method steps: a) mixing the binder component (A) and the aqueous hardener component (B), b) adding the solid component (C) to the mixture obtained in step a), with stirring, to give a coating composition, c) applying the resulting coating composition to a substrate, d) optionally smoothing or deaerating the applied coating composition, and e) curing the applied coating composition, to give the dissipative coating or seal coat, where, if none of components (A), (B), and (C) comprises organic salt, a component (D) comprising the at least one organic salt is admixed in step a) and/or step b).

Application of the coating composition and curing take place advantageously for example at temperatures in the range from 5 to 40° C.

As elucidated, the multicomponent composition may also comprise one or more additional components. The nature and sequence of the addition of the additional components to the mixture of the composition is arbitrary, but preferably one or more additional liquid components, if used, are admixed in step a). One or more additional solid components, if used, are preferably admixed in step b).

The substrate may comprise any desired material. Preferably it is a floor covering, made of concrete, mortar, or screed, for example, which may optionally have a coating, such as a scratchwork filler coating or a primer coating and/or another coating. The other coating of the substrate, to which the coating composition composed of the multicomponent composition of the invention is optionally applied, may comprise, in particular, coats of the kind customary for the construction of a dissipative coating system. They are discussed later on.

The curing reaction begins with the mixing of the multicomponent composition. The epoxy groups of the epoxy resin and optionally of the reactive diluent react with the reactive NH hydrogens to form the organic binder matrix, while the hydraulic inorganic binder with the water, with hydration reactions, forms the inorganic binder matrix, as a result of which the composition ultimately cures. In this way, dissipative coatings or seal coats are obtained.

The invention also relates to a dissipative coating system or floor coating system, more particularly for protecting against electrostatic discharge, comprising a dissipative coating or a dissipative seal coat, the dissipative coating or seal coat being formed of the multicomponent composition of the invention as described above. The dissipative coating system may be obtained by the method of the invention that is described above.

Dissipative coats may also be referred to as electrostatically dissipative coats. Relative to non-dissipative or insulating coats, they allow electrostatic charge which develops to be conducted away. For this purpose, dissipative coats possess a certain electrical conductivity. Dissipative and non-dissipative coats are known to the person skilled in the art.

The dissipative capacity of a coat may be determined, for example, via the resistance to ground of the coat. As used here and unless indicated otherwise, the resistance to ground of a coat may be determined in accordance with the standard IEC 61340-4-1. Here, and in accordance with standards IEC 61340-4-1 and IEC 61340-5-1, a coat is deemed dissipative or electrostatically dissipative if it has a resistance to ground of less than 10⁹ ohms. Coats having a greater resistance to ground are not dissipative. The resistance to ground is determined here for the coats which are in installed form, as described in IEC 61340-4-1.

The resistance to ground and also the system resistance in accordance with the IEC 61340 series of standards may vary within wide ranges, provided dissipative capacity exists. The dissipative coating or seal coat, for example, suitably has a resistance to ground or a system resistance of less than 10⁹ ohms and preferably not more than 5×10⁸ ohms; the resistance to ground may be situated, for example, preferably in the range from 10⁴ ohms to 5×10⁸ ohms. The voltage at which a body is permitted to acquire charge under defined conditions as described in IEC 61340-4-5 (referred to as “body voltage”) is preferably limited to less than 100 volts in accordance with IEC 61340-5-1.

The coat thickness of the dissipative coating or seal coat may likewise vary within wide ranges and may be selected according to the end application. The dissipative coating, for example, has a coat thickness of less than 7 mm, suitably in the range from 5 to 0.5 mm, preferably from 3 to 1 mm.

A grounding means may be located within the dissipative coating system in order to ground the coating system. The coating system may optionally comprise a layer of conductive varnish.

The dissipative coating system may comprise one, two or more dissipative coats. In the case of two or more dissipative coats in the dissipative coating system, only one, or both or all, dissipative coat(s) may be formed of the multicomponent composition of the invention. Alternatively, only one dissipative coat may be formed of the multicomponent composition of the invention, while for the other(s) it is possible to use a customary dissipative coat in accordance with the prior art.

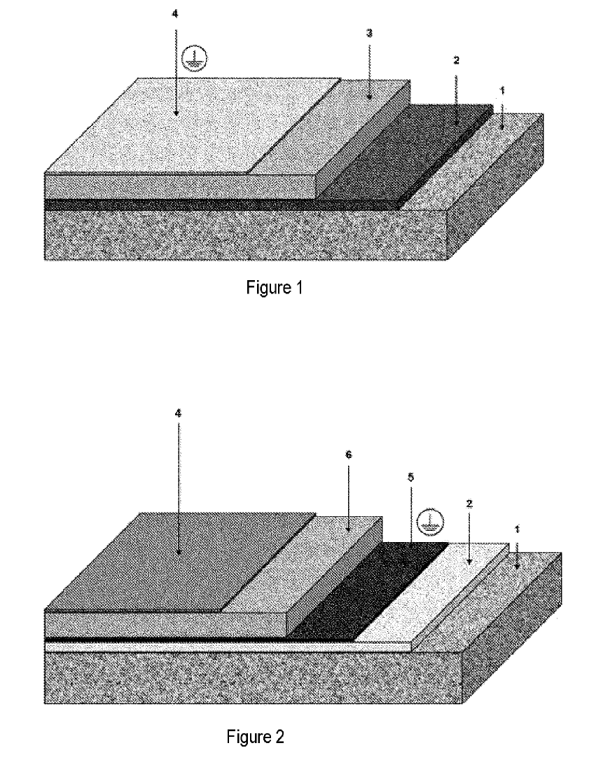

One example of a construction of a dissipative coating system is shown for illustration in FIG. 1. The coating system, on a substrate 1, for the purpose of protecting from electrostatic discharge, comprises, in this order, a priming coat 2 and optionally a leveling coat on the substrate 1; an optional non-dissipative coating 3; and a dissipative coating or seal coat 4.

A further example of a construction of a dissipative coating system is shown for illustration in FIG. 2. It consists of the following individual layers:
1. Thin-bed dissipative coating or seal coat 4
2. Thick-bed dissipative coating 6 (e.g., 10⁴-10⁸ ohms)
3. Conductive varnish 5 and conduction set composed, for example, of copper strips for the grounding of the system
4. Priming coat 2 and optional scratchwork filler coating
5. Substrate 1, e.g., concrete

The dissipative coats shown in FIGS. 1 and 2 may be formed of the multicomponent composition of the invention. In FIG. 2, one of the dissipative coats may be formed of the multicomponent composition of the invention, and the other of a customary, prior-art dissipative coat, or both dissipative coats may be formed of the multicomponent composition of the invention.

The invention also relates to the use of the multicomponent composition of the invention for forming dissipative coatings or seal coats in floor coating systems, especially ESD floor coating systems. The floor coating systems comprise, for example, floors for clean rooms, production facilities, assembly facilities, laboratories, stores, especially solvent stores, or medical rooms.

Examples follow which elucidate the invention, but which are not intended in any way to restrict the scope of the invention.

### EXAMPLES

Commercial products used are as follows:

| | |
|---|---|
| D.E.H. ® 804 | aqueous amine hardener, polyamine-polyepoxide |
| | adduct, solids content 70 wt %, Dow Chemical |
| | Company |
| Byk-019 ® | silicone-containing defoamer, Byk |
| EFKA ®-2550 | defoamer, modified polydimethylsiloxane, BASF |
| Hostatint ®White R | binder-free aqueous pigment preparation, pigment |
| 30 | content 70 wt %, Clariant |
| Colanyl ®Blue B2G | binder-free aqueous pigment preparation, pigment |
| 131 | content 47 wt %, Clariant |
| Hostatint ®Pink E 30 | binder-free aqueous pigment preparation, pigment |
| | content 42 wt %, Clariant |
| Colanyl ®Black N | binder-free aqueous pigment preparation, pigment |
| 131 | content 40 wt %, Clariant |
| Sika ® Repair/ | aqueous epoxy resin dispersion |
| Sikafloor ® | |
| EpoCem ® Module A | solids content about 64%, EEW 295 |
| | Sika Schweiz AG |
| Sikafloor ®-81 | pulverulent, cement-containing component |
| EpoCem ® (C) | cement content about 37%, Sika Schweiz AG |
| White cement | cement CEM I 52.5R, Valderrivas |

### Example

A three-component composition was formulated with the constituents in accordance with table 1 below. The table also indicates in which of the components (binder component A, hardener component B, or solid component C) the constituent is located. Table 2 lists properties of the composition.

TABLE 1
Composition

| | |
|---|---|
| Raw material | (Parts by weight) |

| | | |
|---|---|---|
| Component A | | |
| Sika ® Repair/Sikafloor ® EpoCem ® | | 13.900 |
| Module A | | |
| Component B | | |
| D.E.H. ® 804 | 7.600 | 16.700 |
| BYK ®-019 | 0.070 | |
| EFKA ®-2550 | 0.035 | |
| Water | 4.800 | |
| Benzyltriethylammonium chloride | 2.500 | |
| Hostatint ® white R 30 | 1.525 | |
| Hostatint ® pink E 30 | 0.100 | |
| Colanyl ® blue B 2 G 131 | 0.050 | |
| Colanyl ® black N 131 | 0.020 | |
| Component C | | |
| Sikafloor ®-81 EpoCem ® (C) | | 70.000 |

TABLE 2
Properties

| | Value |
|---|---|
| Organic binder content [wt %] | 14.0 |
| Pigment content [wt %] | 1.3 |
| Cement content (C) [wt %] | 25.7 |
| Water content (W) [wt %] | 12.1 |
| W/C ratio | 0.47 |
| Stoichiometric ratio [in %] | 92.4 |
| Density of mixture while still liquid [g/ml] | 1.9 |
| Tensile adhesion value after 7 d at 23° C. 50% rh | >2 |
| (>50% concrete fracture at C20/25) [N/mm²] | |
| Amine number [mg KOH/g] | 154 |
| Viscosity of amine component: | 200 |
| (D50 1/s at 23° C.) [mPas] | |
| Viscosity of epoxy component: | 400 |
| (D50 1/s at 23° C.) [mPas] | |
| Shore D (7 d 23° C. 50% rh) | 78 |

Preparation of Component B:

The aqueous amine compound is introduced initially into a suitable vessel and the further raw materials are added with stirring using a dissolver in the order stated.

Preparation of the Coating Composition:

For the preparation of the mixture, components A, B, and C were mixed in a mixing ratio of 50/60/250. Components A and B were mixed in the stated mixing ratio with a paddle stirrer, and, after thorough mixing (around 1-2 minutes), component C was added continuously, and the mixture was mixed for a further time of around 3 minutes.

Coating Example as Per FIG. 1 (Without Coat 3):

The formulation of the example is poured onto a fiber cement slab primed with an EP resin and provided with a self-adhesive copper strip, and is spread uniformly using a toothed applicator. Subsequently the formulation is additionally deaerated by means of pins. The consumption of material in this example is about 4 kg/m², thus giving a coating approximately 2 mm thick. The working here conforms to that of a conventional, solvent-free EP system. The surface obtained after hardening has a satin-sheen appearance.

TABLE 3
Dissipative capacity of the system of FIG. 1 (without coat 3):

| Age | | Atmospheric | | Requirement under |
|---|---|---|---|---|
| of coating | Temperature | humidity | Maximum | IEC 61340-4-1 |
| [d] | [° C. ] | [%] | [kΩ] | [kΩ] |
| 1 | 23 | 40 | 14 | <1000.000 |
| 7 | 21 | 39 | 37 | |
| 28 | 22 | 32 | 53 | |
| 66 | 21.6 | 33 | 1750 | |

Coating Example as Per FIG. 2 (Without Coat 6):

A primer such as, for example, Sikafloor-161, a self-adhesive copper strip, and a conductive film such as Sikafloor-220W conductive are applied to a fiber cement slab. The formulation of the example is poured onto this system and is spread uniformly using a toothed applicator. Subsequently the formulation is additionally deaerated by means of pins. The consumption of material in this example is about 4 kg/m², thus giving a coating approximately 2 mm thick. The working here conforms to that of a conventional, solvent-free EP system. The surface obtained after hardening has a satin-sheen appearance.

TABLE 4
Dissipative capacity of the system of FIG. 2 (without coat 6):

| Age | | Atmospheric | | Requirement under |
|---|---|---|---|---|
| of coating | Temperature | humidity | Maximum | IEC 61340-4-1 |
| [d] | [° C. ] | [%] | [kΩ] | [kΩ] |
| 1 | 23 | 40 | 39 | <1000.000 |
| 7 | 21 | 39 | 510 | |
| 28 | 22 | 32 | 1300 | |
| 66 | 21.6 | 33 | 4700 | |

### LIST OF REFERENCE NUMERALS

1 Substrate

2 Priming coat

3 Non-dissipative (insulating) coat

4 Dissipative coating or seal coat

5 Conductive varnish

6 Dissipative coating or seal coat

1. A multicomponent composition comprising
A) a binder component (A) comprising at least one epoxy resin,
B) an aqueous hardener component (B) comprising at least one amine compound as amine hardener and water, and
C) a solid component (C) comprising at least one hydraulic inorganic binder,
where the multicomponent composition comprises at least 8 wt % of organic binder, based on the total weight,
where the total amount of epoxy resin and amine hardener constitutes the organic binder, and
where the multicomponent composition comprises at least one organic salt.

2. The multicomponent composition as claimed in claim 1, wherein the organic salt is selected from a tetraalkylammonium salt, tetraalkylphosphonium salt, imidazolium salt, pyrrolidinium salt, dicyanamide, or pyridinium salt.

3. The multicomponent composition as claimed in claim 1, wherein the at least one organic salt is present in component A, B, C, or in an additional component D.

4. The multicomponent composition as claimed in claim 1, wherein the multicomponent composition comprises 0.5 to 15 wt % of the at least one organic salt, based on the total weight.

5. The multicomponent composition as claimed in claim 1, wherein the multicomponent composition further comprises at least one pigment as coloring agent in at least one of components A), B), or C), and/or in at least one additional pigment component D), where the pigment is used in the form of a pigment preparation, and/or where the multicomponent composition comprises 0.5 wt % to 20 wt %, based on the total weight, of the at least one pigment as coloring agent.

6. The multicomponent composition as claimed in claim 1, wherein the multicomponent composition comprises 8 wt % to 50 wt % of hydraulic inorganic binder, based on the total weight.

7. The multicomponent composition as claimed in claim 1, wherein the multicomponent composition comprises not more than 40 wt % of organic binder, based on the total weight.

8. A method for producing a dissipative coating system comprising a dissipative coating or a dissipative seal coat comprising a multicomponent composition as claimed in claim 1 which comprises
a) mixing the binder component (A) and the aqueous hardener component (B),
b) adding the solid component (C) to the mixture obtained in step a), with stirring, to give a coating composition,
c) applying the resulting coating composition to a substrate,
d) optionally smoothing or deaerating the applied coating composition, and
e) curing the applied coating composition to give the dissipative coating or seal coat,
where, if none of components (A), (B), and (C) comprises organic salt, a component (D) comprising the at least one organic salt is admixed in step a) and/or step b).

9. The method as claimed in claim 8, wherein one or more additional liquid components are admixed in step a) and/or one or more additional solid components are admixed in step b).

10. A dissipative coating system comprising a dissipative coating or a dissipative seal coat, where the dissipative coating or seal coat is formed from the multicomponent composition as claimed in claim 1.

11. The dissipative coating system as claimed in claim 10, obtainable by a method comprising a dissipative coating or a dissipative seal coat wherein the multicomponent composition comprises
a) mixing the binder component (A) and the aqueous hardener component (B),
b) adding the solid component (C) to the mixture obtained in step a), with stirring, to give a coating composition,
c) applying the resulting coating composition to a substrate,
d) optionally smoothing or deaerating the applied coating composition, and
e) curing the applied coating composition to give the dissipative coating or seal coat,
where, if none of components (A), (B), and (C) comprises organic salt, a component (D) comprising the at least one organic salt is admixed in step a) and/or step b).

12. The dissipative coating system as claimed in claim 10, where the dissipative coating or seal coat has a resistance to ground of less than 10⁹ ohms, determined according to IEC 61340-4-1.

13. The dissipative coating system as claimed in claim 10, wherein the coating system accommodates a grounding means for grounding the coating system, and/or the coating system optionally comprises a conductive varnish layer.

14. The multicomponent composition as claimed in claim 1 for forming dissipative coatings or dissipative seal coats in coating systems or floor coating systems.

15. The multicomponent composition as claimed in claim 14 for floor coating systems in clean rooms, production facilities, assembly facilities, laboratories, stores, especially solvent stores, and medical rooms.
